(19) United States
(12) Patent Application Publication
(10) Pub. No.: US 2019/0225520 A1
(43) Pub. Date: Jul. 25, 2019

(54) UV-SYSTEM WITH A DEGASSING ZONE

(71) Applicant: Xylem IP Management S.à r.I., Senningerberg (LU)

(72) Inventors: Arne Wieland, Minden (DE); Wiebke Rand, Bielefeld (DE)

(73) Assignee: Xylem IP Management S.à r.I., Senningerberg (LU)

(21) Appl. No.: 15/998,615

(22) PCT Filed: Feb. 8, 2017
(86) PCT No.: PCT/EP2017/052746

§ 371 Date: Aug. 16, 2018

(30) Foreign Application Priority Data
Feb. 16, 2016 (EP) 16155896.0

(51) Int. Cl. C02F 9/00

(52) U.S. Cl. CPC C02F 9/00; C02F 1/20

(57) ABSTRACT

In a liquid treatment system with an inlet and an outlet defining a liquid flow direction from the inlet to the outlet, a liquid treatment zone is arranged between the inlet and the outlet. The liquid treatment zone includes ultraviolet radiators arranged to radiate ultraviolet radiation into a liquid flowing through the treatment zone. A first transition zone downstream of the inlet and a second transition zone upstream of the outlet, adapt the cross section of the inlet to the cross section of the treatment zone, and the cross section of the treatment zone to the cross section of the outlet, respectively. The inlet, the transition zones, the treatment zone and the outlet confine the liquid flow in a closed channel, so greater durability of the radiators and the channel wall material is achieved by providing a degassing between the inlet and the treatment zone at the top of the channel.

### CROSS-REFERENCE TO RELATED APPLICATIONS

This patent application is a U.S. National Phase Patent Application of PCT Application No.: PCT/EP2017/052746, filed Feb. 8, 2017, which claims priority to European Patent Application No. 16155896.0, filed Feb. 16, 2016, each of which is incorporated by reference herein in its entirety.

### FIELD OF THE INVENTION

The present invention relates to a liquid treatment system.

### BACKGROUND OF THE INVENTION

A system of this type is known from U.S. Pat. No. 8,148,699 B2.

Generally, these systems are called “fluid treatment systems” because they work for gases, liquids, suspensions and the like. Throughout this patent application, the term “liquid treatment system” is used because the medium to be treated shall be essentially free of gaseous components which might interfere with the intended purpose. In this sense, a liquid should be understood as a flowing medium, which may contain different liquid phases and suspended solid particles, but no significant amount of gas.

The known liquid treatment system, like other similar systems, comprises a closed channel or housing, in which a number of UV radiators are arranged. The exact way how the radiators are oriented in the channel is not relevant in the present context.

Such closed channel systems are used to treat drinking water or wastewater. They are attached to a pipe which feeds the water to be treated into an inlet. The cross-section at the inlet is generally circular. From the circular inlet, there is a transition region which has a conical shape and leads the circular inlet to a rectangular conduit of larger cross-section. This means that the flow of water is enlarged in cross-section and therefore the velocity of the flow is reduced. Downstream of the transition section, there is the reactor housing itself, which is of essentially rectangular or quadratic cross-section, with minor deviations due to manufacturing requirements, attachments, fitting and the like. This section also houses the radiators. Downstream of the treatment zone, the water flow, which is now treated with a certain dose of ultraviolet radiation, leaves the treatment zone and enters a second transition zone in which the quadratic cross-section of the treatment zone is transformed to a circular cross-section of smaller diameter for attachment to an outflow pipe.

Reactors of the known type cannot only be used for disinfection purposes, but also for so called advanced oxidation processes. Contaminations with organic substances are increasingly recognized as harmful to health, so that their removal is necessary. On the other hand more and more such substances are detected in the groundwater and surface water. An example of this is the increasing concentration of pharmaceutical residues in surface waters. Such contamination can be reduced by various technologies like adsorption, oxidation or UV irradiation of organic contaminants. The advanced oxidation process is the most beneficial one. It uses the combination of strong oxidant like hydrogen peroxide and gaseous ozone to produce hydroxyl radicals which are then capable of cracking the molecule into shorter parts. These shorter parts then can be further degraded by ultraviolet radiation where residuals of the oxidations are forming hydroxyl radicals as well.

One problem with combined advanced oxidation processes with ozone, hydrogen peroxide and UV, if they are carried out in larger systems, are the gas bubbles. These bubbles are created during the ozone step and have to be removed from the system. Gas bubbles have a negative impact on the performance of the UV-system because the UV-transmission and accordingly the absorption of UV-light by the target substances is significantly reduced.

### SUMMARY OF THE INVENTION

It is therefore an object of the present invention to provide a liquid treatment system, which is effective in AOP processes, which can be used in large-scale installations and which has no negative impact on the performance of the UV-system.

In a liquid treatment system with an inlet and an outlet defining a liquid flow direction from the inlet to the outlet, a liquid treatment zone arranged between the inlet and the outlet, the liquid treatment zone comprising a number of ultraviolet radiators arranged to radiate ultraviolet radiation into a liquid flowing through the treatment zone, a first transition zone downstream of the inlet and a second transition zone upstream of the outlet, which adapt the cross section of the inlet to the larger cross section of the treatment zone, and the cross section of the treatment zone to the cross section of the outlet, respectively, wherein the cross-section of the treatment zone is larger than the cross-section of the inlet, and wherein the inlet, the transition zones, the treatment zone and the outlet confine the liquid flow in a closed channel, greater durability of the radiators and the channel wall material is achieved by providing a degassing zone, between the inlet and the treatment zone for separating undissolved gas from the liquid and removing the separated gas from the system, wherein the degassing zone comprises side wall means and top wall means which can confine a gas volume at the top of the channel above the liquid.

It is preferred that a degassing zone is provided between the first transition zone and the treatment zone, because in this degassing zone, the flow rate can be decreased and thus degassing effectively supported.

The length of the degassing zone, in the direction of the flow, may be 10% to 50% of the length of the treatment zone. In a preferred embodiment the length of the degassing zone may be 20% to 30% of the length of the treatment zone.

It is preferred that the degassing zone is of essentially the same shape and cross section as the treatment zone, and that no ultraviolet radiators are provided in the degassing zone. This arrangement makes the construction less complex. A degassing device may be arranged to communicate with the degassing zone with the advantage that the gas can be handled by the degassing device.

Advantageously, the treatment zone and the degassing zone are of essentially rectangular cross section with longitudinal edges and that, relative to a horizontal plane, the edges are oriented essentially horizontally, namely with inclination angles between −10 degrees to +10 degrees relative to a horizontal plane, and one upper edge is located at the top of the system. This way, the gas can be collected under the top edge of the channel. The terms “top” and horizontal” are defined with respect to the direction of gravitation, which is assumed as acting in a vertical direction, because it is the influence of gravitation that lets the undissolved gas bubbles rise to the top of the fluid.

It is further preferred if the degassing device is located at the upper edge of the system.

It is an advantage when the degassing zone comprises side wall means and top wall means which are adapted to hold a gas volume which is separated from and located above the flow of liquid, because these wall means can confine a volume of gaseous phase above the liquid. In the case of gases which contain a proportion of ozone, this helps to prevent the uncontrolled release of ozone to the atmosphere.

While the degassing zone is provided to collect undissolved gas, the degassing device is provided to remove this gas from the system. This is achieved in a preferred manner if the degassing device has an inlet, which is open to the gas volume and adapted to convey gas from the degassing zone into venting means for guiding the gas out of the system.

In a preferred embodiment an ozone mixing device for mixing gaseous ozone enriched gas into the liquid is provided upstream of the degassing zone, so that advanced oxidation processes (AOP) can be carried out in the system.

Degassing can be more effectively carried out if the degassing zone comprises a baffle plate which is arranged at the top edge of the degassing zone upstream of the treatment zone and downstream of the degassing device.

The baffle plate may advantageously be fitted to the walls of the degassing zone in a way that gas collected upstream of the baffle plate along the upper edge of the degassing zone is prevented from entering the treatment zone.

Preferably, the degassing device is dome-shaped and comprises an internal volume for collection of the gas, which is released from the liquid prior to the venting of the gas. This feature makes the device compact and effective.

To remove the gas, it is preferred that the degassing device comprises an opening for venting of the collected gas from the degassing zone. In a further preferred embodiment, the opening is closable, depending on the signal of an electronic controller. This enables the system to collect gas over a certain time, if desired, and vent gas at controlled times, after a certain volume is collected, or in intervals.

The degassing device may preferably comprise a degassing valve, which may be operated automatically in order to vent collected gas from the degassing zone.

It is preferred that the valve communicates with an ozone-degrading device for destructing any remaining ozone in the vented gas. In the case of AOP procedures being carried out in the system, the release of ozone to the atmosphere can be prevented.

### BRIEF DESCRIPTION OF THE DRAWING FIGURES

In the following, a preferred embodiment of the present invention is described with respect to the figures. The figures show:

FIG. 1: a schematic representation of an advance oxidation process;

FIG. 2: a reactor according to the present invention in a side elevation, in schematic representation;

FIG. 3: a cross-section through the degassing zone of the reactor of FIG. 2; and

FIG. 4: a reactor with inlet and outlet in a perspective representation.

### DETAILED DESCRIPTION OF THE INVENTION

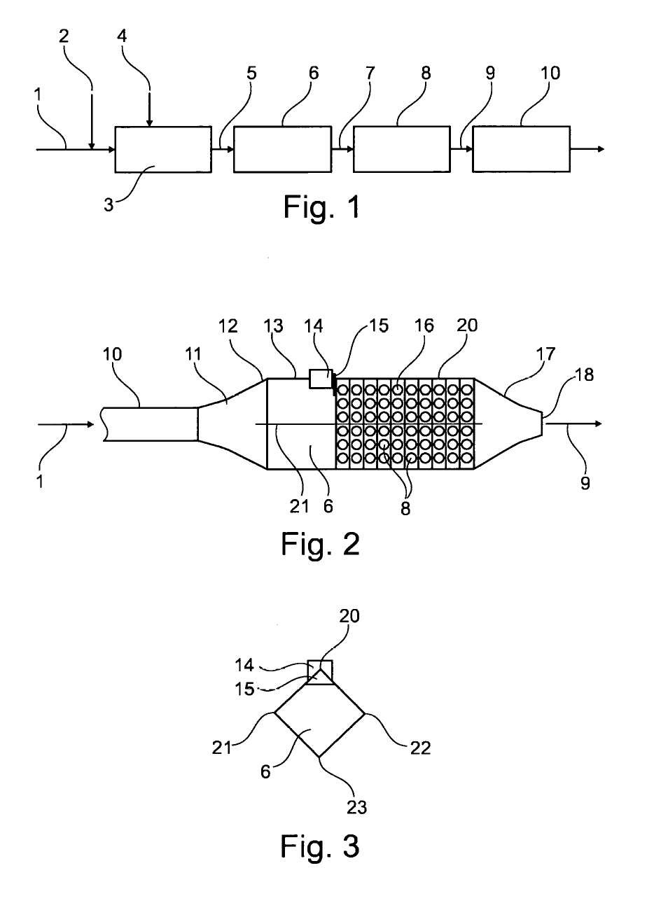

FIG. 1 shows the steps of an AOP process for treating raw water, which may be effluent from a waste dump side, contaminated ground water or similar water that needs to be treated for persistent chemicals like endocrine substances. The pre-treated raw water 1 may be contacted with hydrogen peroxide 2 in a first step. This step is an option. The raw water 1 is then fed into an ozone mixing and reaction system 3, in which the raw water 1 is contacted with ozone 4, namely an ozone containing gas like oxygen with an ozone content up to 20%, or with air which is enriched in ozone by a known process. The ozone 4 will then be dissolved in the raw water stream, depending on the efficiency of the ozone mixing system. There will inevitably be some gaseous ozone or other gaseous components remaining un-dissolved in the raw water at an outlet 5 of the ozone mixing and reaction system 3. The dissolved ozone, however, is reacting with the contamination at this point. After that, a degassing zone 6 for the ozone containing gas is provided. This degassing zone is intended to remove the non-dissolved gas from the water stream. At the outlet of the degassing zone 6, the pre-treated raw water 7 is essentially free of non-dissolved gas. At this point, a UV system with UV radiators 8 is entered and the pre-treated water stream 7 is subject to an irradiation with ultraviolet rays of a certain dose. At the outlet 9, the treated water stream contains significantly less persistent chemical components, which have been degraded by the AOP process as briefly described above.

Optionally, further filtration steps 19 may follow the AOP process.

A UV treatment system according to the present invention is shown in a schematic side elevation in FIG. 2. The pre-treated raw water 1 enters the system through an inlet 10 of circular cross-section. A transition zone 11 is attached to the inlet, which transforms the cross-section of the closed inlet channel from circular cross-section to a rectangular or quadratic cross-section of larger dimensions, thus enlarging the cross-section of the flow and reducing the flow velocity. At the end 12 of the transition zone 11, the flow velocity is significantly reduced, which allows un-dissolved gas, which is present as bubbles, to rise to the top of the installation. The transition zone 11 is directly followed by a degassing zone 13, which has the same enlarged rectangular cross-section as the end 12 of the transition zone 11. In the degassing zone 13, the gas bubbles, which are still present in the raw water 1, rise to the top of the installation. A degassing device in the form of a dome 14 may be provided to collect the gas at the end of the degassing zone 13, and a vent valve (not shown) may be provided to vent any collected gas from the dome 14. A separation plate or baffle plate 15 is provided downstream of the dome 14, which separation or baffle plate 15 represents the end of the degassing zone and prevents any gas bubbles which are collected at the top of the degassing zone from entering the following irradiation zone or treatment zone 16, in which the pre-treated raw water, which is now contacted with dissolved ozone, will be purified. Downstream of the treatment zone 16, a second transition zone 17 is provided in order to reduce the cross-section of the system from the cross-section of the degassing zone and the treatment zone to the smaller, circular cross-section of an outlet 18, which feeds the treated raw water 9 into further pipe systems and optionally into further filtration steps.

A cross-section of the degassing zone at the point where the dome 14 and the baffle plate 15 are provided is shown in FIG. 3. As can be seen in FIG. 3, the orientation of the cross-section of the degassing zone, and of the following treatment zone, which is not visible here, is such that the cross-section is quadratic with four edges. In a preferred embodiment, the housing of the system is set up such that one edge 20 is at the top of the system, so that any collected gas can be concentrated along that edge. Consequently, there are other edges 21 (which is already visible in FIG. 2), 22 and 23, wherein the edges 21 and 22 are side edges, while edge 23 is a bottom edge. The orientation of the cross-section and the housing of the degassing zone 6 and the treatment zone 8 therefore promote the removal of the gas contained in the pre-treated raw water downstream of the ozone mixing and reaction system 3.

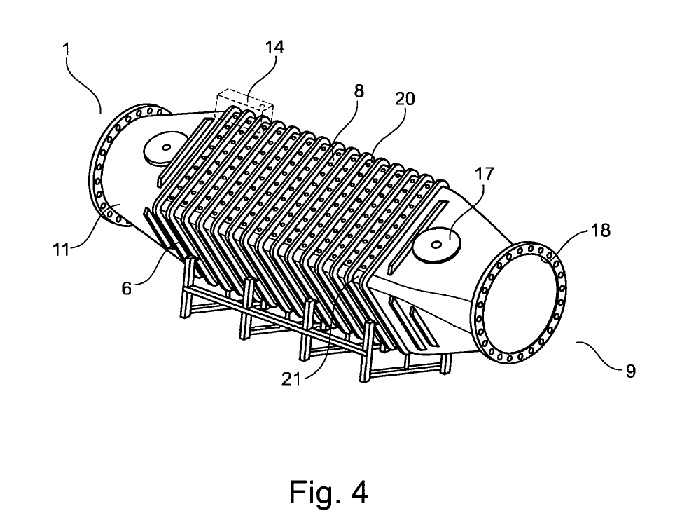

FIG. 4 finally shows a perspective representation of the system as described above. It can be understood that the orientation of the cross-section of the degassing zone 6 and the treatment zone 8 facilitate the collection of undissolved gas along the upper edge 20 of the device.

1.-16. (canceled)

17. A liquid treatment system comprising:
an inlet and an outlet defining a liquid flow direction from the inlet to the outlet,
a liquid treatment zone arranged between the inlet and the outlet, the liquid treatment zone comprising a number of ultraviolet radiators arranged to radiate ultraviolet radiation into a liquid flowing through the treatment zone,
a first transition zone downstream of the inlet that adapts a cross section of the inlet to a cross section of the treatment zone,
a second transition zone upstream of the outlet that adapts the cross section of the treatment zone to a cross section of the outlet,
the cross-section of the treatment zone is larger than the cross-section of the inlet,
the inlet, the transition zones, the treatment zone and the outlet confine the liquid flow in a closed channel, and
a degassing zone is disposed between the inlet and the treatment zone, and the degassing zone comprises a side wall and a top wall which are configured to confine a gas volume at the top of the channel above the liquid.

18. The liquid treatment system according to claim 17, wherein the degassing zone is disposed between the first transition zone and the treatment zone.

19. The liquid treatment system according to claim 18, wherein the degassing zone is of substantially a same shape and cross section as the treatment zone, and no ultraviolet radiators are provided in the degassing zone.

20. The liquid treatment system according to claim 17, further comprising a degassing device arranged to communicate with the degassing zone.

21. The liquid treatment system according to claim 17, wherein the treatment zone and the degassing zone are of substantially rectangular cross section with longitudinal edges and, relative to a horizontal plane, the longitudinal edges are oriented at angles between +10 degrees and −10 degrees against the horizontal plane, and one upper edge is located at the top of the system.

22. The liquid treatment system according to claim 21, wherein the degassing device is located at the upper edge of the system.

23. The liquid treatment system according to claim 17, wherein the degassing zone is configured to hold a gas volume which is separated from and located above the flow of liquid.

24. The liquid treatment system according to claim 20, wherein the degassing device has an inlet which is open to the gas volume and adapted to convey gas from the degassing zone into a vent for guiding the gas out of the liquid treatment system.

25. The liquid treatment system according to claim 17, further comprising an ozone mixing device for mixing gaseous ozone enriched gas into the liquid located upstream of the degassing zone.

26. The liquid treatment system according to claim 20, wherein the degassing zone comprises a baffle plate which is arranged at the top of the degassing zone upstream of the treatment zone and downstream of the degassing device.

27. The liquid treatment system according to claim 26, wherein the baffle plate is fitted to the walls of the degassing zone such that gas collected upstream of the baffle plate along the top of the degassing zone is prevented from entering the treatment zone.

28. The liquid treatment system according to claim 20, wherein the degassing device is dome-shaped and comprises an internal volume for collecting gas which is released from the liquid prior to the venting of the gas.

29. The liquid treatment system according to claim 20, wherein the degassing device comprises an opening for venting the collected gas from the degassing zone.

30. The liquid treatment system according to claim 29, wherein the opening is closable, depending on a signal from an electronic controller.

31. The liquid treatment system according to claim 20, wherein the degassing device comprises a degassing valve, which is configured to be operated automatically in order to vent collected gas from the degassing zone.

32. The liquid treatment system according to claim 31, wherein the degassing valve communicates with an ozone-degrading device for destroying any remaining ozone in the vented gas.
